(19) United States
(12) Patent Application Publication
(10) Pub. No.: US 2005/0064120 A1
(43) Pub. Date: Mar. 24, 2005

(54) Process and apparatus for producing synthetic bottle closures

(76) Inventors: Johannes Volpini, Seeboden (AT); Kurt Diblik, Bruck (AT)

Correspondence Address: OSTROLENK FABER GERB & SOFFEN, 1180 AVENUE OF THE AMERICAS, NEW YORK, NY, 100368403, US

(21) Appl. No.: 10/883,323

(22) Filed: Jul. 1, 2004

(30) Foreign Application Priority Data
Jul. 4, 2003 (EP) 03015186.4

(51) Int. Cl. F16L 1/00; B32B 1/08

(52) U.S. Cl. 428/35.7; 428/364; 264/45.9; 425/131.1

(57) ABSTRACT

A process for producing synthetic bottle closures composed of a cylindrical core element made from a foamed polymer material and of an outer layer composed of a compact and unfoamed polymer material, connected to said core element and enveloping it, the polymer melts being prepared in a first and a second extruder and joined in a manifold die such that an enveloped melt strand emerges which is taken off and then, after curing is cut and chamfered. The polymer melt for the core material is mixed at least once between the first extruder and the manifold die and is subsequently cooled.

The invention relates to a process for producing synthetic bottle closures composed of a cylindrical core element made from a foamed polymer material and of, connected to said core element and enveloping it, an outer layer composed of a compact polymer material, the polymer melts being prepared in a first and a second extruder and joined in a manifold die such that an enveloped melt strand emerges which is taken off and after curing is cut and chamfered.

The invention further relates to a coextrusion unit for producing synthetic bottle closures composed of a cylindrical core element made from foamed polymer, having, connected to said core element and enveloping it, an outer layer composed of a compact polymer material, said unit having a first extruder for preparing the polymer melt for the core element, a second extruder for preparing the polymer melt for the outer layer, a manifold die for combining the melts such that the melt for the core element is surrounded annularly by the melt for the outer layer, an exit die, a cooling section, a take off means, and a cutting and chamfering means.

EP-B-1 051 334 discloses a synthetic bottle closure which is composed of a cylindrically shaped core element made from a foamed, closed-cell polymer material and of an outer layer which is composed of a preferably likewise foamed polymer material and which peripherally surrounds the cylindrical surface of the core element and is integrally bonded to it. That document also pertains to a process for producing such a bottle closure, which according to the claims of the patent is said essentially to comprise extruding a cylindrical polymer core element whose cylindrical surface is joined to a separate, independent layer of a polymer material in order to prevent passage of liquid between the core element and the peripheral layer. The two-layer article produced is cut in a plane extending perpendicularly with respect to the center axis of the core element, producing a multilayer thermoplastic bottle closure which has the desired length for insertion and retention in the portal of a container neck. It is mentioned that the peripheral layer and the foamed polymer core element can be produced by coextruding polymer melts.

Coextrusion fundamentally is a long-established process. Thus, for example, the “Handbuch der Kunststoff-Extrusionstechnik II, Extrusionsanlagen”, 1986 (Hanser Verlag) mentions various coextrusion processes for producing foamed semifinished products from two different flows of composition, with a foamed core, using single-screw extruder units. Page 443, section 13.5.1, single-screw extruder units, describes the basic construction of such a unit, comprising besides the extruder with its premixing means a calibrating and cooling means, and also takeoff, sawing and stacking means. It is also mentioned that the solutions devised in this field are results of intensive development and for the most part have been or are protected under patent law.

The intention, then, is that it should be possible to produce synthetic bottle closures economically and with technically acceptable effort which in terms of their properties, particularly the recovery, the extraction forces and the sealing, should at least match and in particular should be superior to natural cork. Natural cork as a starting material for bottle closures has become increasingly rare and hence is also increasingly in demand and comparatively expensive. With natural cork, moreover, there are very sharp differences in quality and, accordingly, large differences in price as well. The differences in quality make it frequently difficult to ensure durably sealing closure of a bottle; at the same time, however, the opening of the bottle, in other words the extraction of the stopper, ought not to be too difficult. Also of importance is that synthetic bottle closures should differ very little externally from stoppers made from natural cork. In this respect the extruded plastic closures known to date have an advantage over those produced by injection molding.

The aforementioned EP-B-1 051 334 cites certain quality features of the synthetic closures disclosed, such as, for example, homogeneous distribution of the closed cells, substantially uniform cell size, etc. Specific parameters, then, are responsible for the bottle closure having precisely specified physical properties and so being executed in accordance with the customer's requirements. To the customer, the wine producer for example, closing his or her bottles one of the things that is important is to be dependent no longer on chance factors in the quality of the stoppers supplied. It is also important to the customer to be able to continue to use his or her bottle closing machines when using plastic closures.

The way in which bottle closures of the demanded and desired quality can be produced is not apparent from EP-A-1 051 334. The merely general mention of the use of a coextrusion process is incapable, as is clearly evident from the technical literature mentioned above, of providing the skilled worker with any particular way in which a product of the desired quality can be produced.

So this is where the invention comes in, its object being to provide a process and apparatus which allow synthetic bottle closures to be produced economically from a foamed core element and a compact outer layer with reproducible quality features.

As far as the process is concerned, the object is achieved in accordance with the invention by mixing the polymer melt for the core material at least once between the first extruder and the manifold die and subsequently cooling it.

As far as the apparatus is concerned the object is achieved by there being between the first extruder and the manifold die at least one static mixer and a cooler. Of particular importance for ensuring that in the core element a uniform cell size and a uniform distribution of the cells comes about is ensuring that in the melt discharged from the extruder the temperature is as uniform as possible over the cross section and that by cooling of the melt, through the rapid drop in pressure following emergence from the die, an optimum foaming operation is possible.

In this context is has been found advantageous if the melt is mixed again after cooling, immediately before the manifold die. The polymer melt therefore enters the manifold die with a temperature which is substantially constant over its cross section, the strand being encased with the polymer melt of the outer layer just before the exit die.

A further measure which influences the uniform cell structure in the core element produced is taken right when supplying the starting materials for the melt of the core element. This measure consists in mixing chemical blowing agent directly into the already metered stream of pellets for the melt of the core element. This specific measure ensures highly uniform incorporation of the blowing agent.

In the process of the invention the melt pressure upstream of the screw tip of the first extruder, depending on throughput, is between 130 bar and 200 bar, and on emergence from the die is of the order of from 50 bar to 100 bar. This measure influences not only the amount of blowing agent used but also the degree of foaming and hence the specific weight, cell structure, cell size and cell distribution of the core element, and contributes to endowing the finished product with properties that are improved as compared with natural cork.

Further features, advantages and details of the invention are described in more detail with reference to the drawing, in which

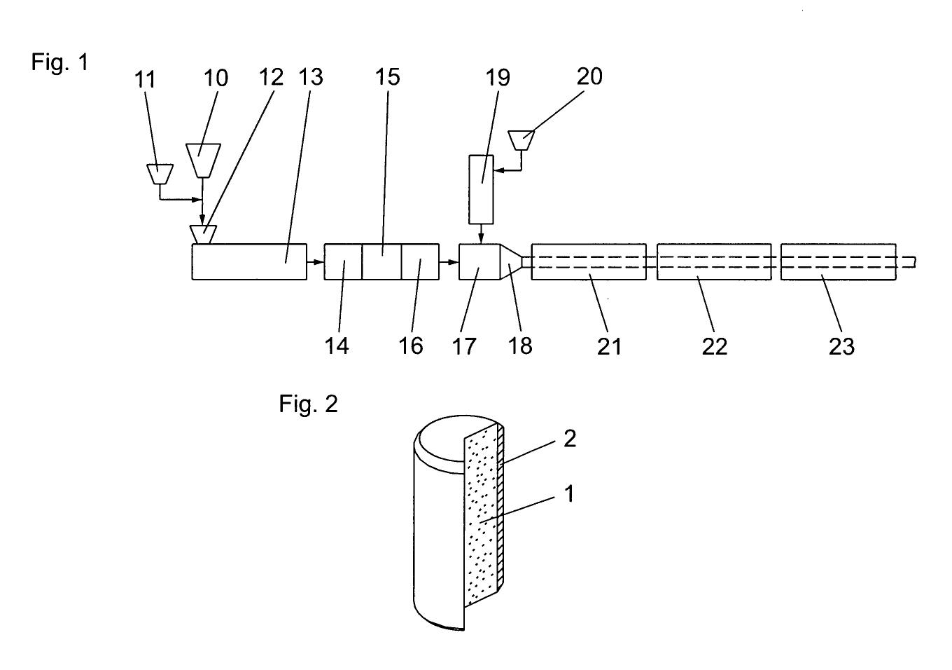

FIG. 1 shows diagrammatically the individual stations of an apparatus for producing a synthetic bottle closure and

FIG. 2 shows a view of a bottle closure produced in accordance with the invention.

FIG. 2 shows a bottle closure in the form of a perfectly cylindrical stopper having a cylindrical core element 1 made from a foamed, closed-cell polymer material and having an outer layer 2 which surrounds and is firmly connected to the core element 1 and is made from a compact, unfoamed polymer material. The outer layer 2 has a thickness of between 0.5 and 2 mm. The average cell size of the polymer material of the core element 1 is between 0.01 mm and 0.05 mm. The cell density is between 1 000 000/cm³ and 8 000 000/cm³.

The invention is concerned with the production of a synthetic bottle closure, as an alternative to natural cork, which in terms of its properties—consistently high quality, sealing, recovery and constant extraction forces, for example—is to be at least equal but in particular superior to natural cork. In this context, above all, the process for producing the bottle closure is of particular importance, but the starting materials also have an important part to play.

Suitable base material for the core element 1 includes a variety of polymer materials, particularly polyethylene, polybutadiene, polybutylene, thermoplastic elastomers, ethylene-acrylic copolymers, ethylene-vinyl acetate copolymers and the like. The polymer material is foamed using one of the customary chemical blowing agents, such as modified azodicarboxamide, polymer-bound, which is available under the commercial designation Tracel.

Base materials for producing the compact outer layer 2 are a thermoplastic elastomer and also at least one color batch, a polymer material admixed with colorant particles. Suitable thermoplastic elastomers include in particular those based on polyester esters, olefin copolymers, ethylene/vinyl acetate, ethylene/vinyl acetate-polyvinylidene chloride, nitrile/butadiene rubber/polypropylene, ethylene/propylene terpolymer/propylene, natural rubber/polypropylene, ethylene/propylene terpolymer/propylene (crosslinked and noncrosslinked), styrene copolymers, styrene/butadiene, styrene/butadiene/styrene, styrene/ethene-butene/styrene, styrene/isoprene, styrene/butylene/styrene-propylene, styrene/ethylene-butylene/styrene-polyphenylene ether, styrene/ethylene-butylene/styrene-polypropylene, styrene/-butadiene/styrene-propylene, polyurethane, polyester urethane, polyether ester urethane, polyether urethane and aliphatic polyurethane. The polymer material of the color batch is colored by means of food-grade colorants to the color of natural cork. Compatibility and miscibility of the color batch or batches with the base polymer material of the outer layer 2 are important for ensuring optimum quality of the resulting product.

The color of natural cork can be imitated with particular trueness to nature by means of a mixture of a beige color batch with a black effect color batch. Both color batches are polymer pellets. Both the color pigments used for the core element 1 and the color pigments used for the outer layer 2 are preferably organic color pigments, in particular various fillers; the carrier material ought to be compatible with the base polymer of the core element and of the outer layer. Inorganic color pigments are highly suitable as nucleating agents when foaming.

With reference to FIG. 1 the apparatus of the invention and the process of the invention for producing bottle closures will now be described in more detail.

In a gravimetric metering means 10 the pellets of the base polymer material and the pellets of the color batches for producing the core element 1 are weighed above the extruder feed section 12 of the main extruder 13 and mixed. The chemical blowing agent is mixed via a separate metering means 11 directly into the stream of pellets coming from the gravimetric metering means 10. This measure ensures optimum distribution of the starting materials in the main extruder 13 and prevents their unwanted separation.

The mixture of the starting materials is melted and homogenized in the main extruder 13. The extruder 13 may be one of the customary extruders with a three-zone screw and a compression ratio of 2.5:1. The melt pressure upstream of the screw tip, depending on throughput, is between 130 bar and 200 bar, and the melt temperature is of the order of from 130° C. to 160° C. In order to obtain a very uniform temperature distribution of the melt over its cross section the melt is discharged from the main extruder 13 directly into a static mixer 14, then cooled in a melt cooler 15 and finally mixed again in a second static mixer 16. In the cooler 15 the melt has heat removed from it preferably in two separate circuits and by means of oil-type thermal conditioning devices.

From the static mixer 16 the melt is transferred to a manifold die 17, in which by means for example of a heart-shaped-curve manifold the outer layer 2 is applied in the form of a thin pipe to the main strand, which forms the core element 1. The starting materials for the outer layer 2 are weighed and mixed likewise by means of a gravimetric metering means 20 above the feed section of a second extruder 19. In the coextruder 19 this mixture is melted and homogenized. The screw used in the coextruder 19 is in particular a barrier screw, which allows the melt temperature and the shear heat to be kept low. The melt, shaped into the form of a pipe by means of the heart-shaped-curve manifold in the die 17, is placed around the melt that forms the core element 1. The enveloped melt strand emerges to the outside through an exit die 18. The abrupt drop in pressure on emergence from the die 18 causes the foaming process of the core element material to begin. The degree of foaming, which determines the specific weight, cell structure, cell size and cell distribution in the core element 1, is determined on the one hand by the amount of blowing agent used but on the other hand additionally by the residence time of the melt in the extruder, the temperature conditions, the pressure regime, the design of the flow path and the die geometry. The pressure gradient of the melt pressure ranges from 130 bar to 200 bar in the region of the screw tip of the extruder 13 down to about from 50 bar to 100 bar in the region of emergence from the die 18 and also, as has been found, has a certain influence on the quality of the finished product, in particular in relation to the homogeneity of the distribution of the cells.

The coextruded strand emerging from the exit die 18 is transported away under tension by means of a takeoff means 22 and at the same time is dimensionally stabilized and adjusted. Immediately after the die 18 the coextruded strand passes first through another cooler 21, which is preferably a water cooler, in which it is cooled to such an extent that the take off means is no longer able to bring about any strand deformations. The takeoff means 22 is, for example, a caterpillar takeoff, composed of PU-coated segments notched with V-shaped grooves. The caterpillar takeoff 22 is operated as far as possible at constant speed, in order not to produce any fluctuations in the diameter of the product. The coextruded strand is then conveyed via a further cooler 23, which serves simultaneously as a buffer section, and on to a cutting means, no longer shown, and the cut bottle closures are fed to a chamfering means and processed appropriately before being packed.

In accordance with the process of the invention the bottle closures were produced for example using the following starting materials:

(The Amounts in % are Based on 100 Percent by Weight)

Outer layer (compact, unfoamed):

| | | |
|---|---|---|
| Thermoplastic elastomer | 93.5% to | 97.5% |
| Color batch, beige | 2% to | 4% |
| Effect color batch, black | 0.5% to | 1.5% |

Core element (foamed):

| | |
|---|---|
| EVA copolymer | 85% |
| LDPE | 12.5% to 14% |
| Chemical blowing agent | 0.5% to 2% |
| Color batch, beige | 0.5% to 1.5% |

The synthetic bottle closures produced were compared with natural corks in respect of a number of properties:

Properties

| | Max. | | | | | |
|---|---|---|---|---|---|---|
| | com- | | | | | Max. |
| | pression | Recovery (from 15.5 mm)* | | | | extraction |
| | force, N | 10 sec | 15 min | 1 h | 24 h | force, N |
| Synthetic | 234 N | 97.9% | 98.9% | 99.1% | 99.4% | 250 N |
| closure | | | | | | |
| Natural | 352 N | 94.7% | 96.2% | 98.3% | 99.5% | 185 N |
| cork | | | | | | |

*Measurement method: compression in diameter from 22 mm to 15.5 mm at 2 mm/sec; the 15.5 mm diameter is maintained for 15 sec and then released at 10 mm/sec; after the stated intervals of time the increase in diameter in percent is taken relative to the initial diameter of 22 mm.

Capillary Action

Both closures are immersed by their end face for 24 hours in a vessel filled to a height of 5 mm. The height to which the liquid has penetrated is then measured.

| | Max. capillary action in mm |
|---|---|
| Synthetic closure | 0.00 |
| Natural cork | 20.5 |

1. A process for producing synthetic bottle closures composed of a cylindrical core element made from a foamed polymer material and of, connected to said core element and enveloping it, an outer layer composed of a compact and unfoamed polymer material, the polymer melts being prepared in a first and a second extruder and joined in a manifold die such that an enveloped melt strand emerges which is taken off and after curing is cut and chamfered, which process comprises the steps of:
mixing the polymer melt for the core material at least once between the first extruder and the manifold die; and
subsequently cooling it the polymer melt.

2. The process as claimed in claim 1, wherein the melt is mixed again after cooling, immediately before enveloping in the manifold die.

3. The process as claimed in claim 1, wherein before being fed into the first extruder a chemical blowing agent is mixed by a separate metering device directly into the already metered stream of pellets for the melt of the core element.

4. The process as claimed in claim 1, wherein the melt pressure of the melt for the core element is set such that at a screw tip of the extruder it is between 130 bar and 200 bar and in the region of an exit die it has fallen to from 50 bar to 100 bar.

5. The process as claimed in claim 3, wherein the polymer pellet starting materials for the core element and of the outer layer are metered gravimetrically.

6. The process as claimed in claim 1, wherein the starting materials for the outer layer and/or the core element comprise at least one type of polymer pellets containing color pigments, said pellets being compatible with the base polymer material and said color pigments in particular being organic color pigments.

7. The process as claimed in claim 1, wherein the polymer material for the core element comprises at least one material selected from the group consisting of polyethylene, polybutadiene, polybutylene, thermoplastic elastomers, ethylene-acrylic copolymers, and ethylene-vinyl acetate copolymers.

8. The process as claimed in claim 1, wherein the polymer material for the compact outer layer comprises at least one thermoplastic elastomer selected from the group consisting of polyester esters, olefin copolymers, ethylene/vinyl acetate, ethylene/vinyl acetate-polyvinylidene chloride, nitrile/butadiene rubber/polypropylene, ethylene/-propylene terpolymer/propylene, natural rubber/polypropylene, ethylene/propylene terpolymer/propylene (crosslinked and noncrosslinked), styrene copolymers, styrene/butadiene, styrene/butadiene/styrene, styrene/ethene-butene/styrene, styrene/isoprene, styrene/butylene/-styrene-propylene, styrene/ethylene-butylene/styrene-polyphenylene ether, styrene/ethylene-butylene/styrene-polypropylene, styrene/butadiene/styrene-propylene, polyurethane, polyester urethane, polyether ester urethane, polyether urethane and aliphatic polyurethane.

9. A coextrusion unit for producing synthetic bottle closures composed of a cylindrical core element made from foamed polymer, and having, connected to said core element and enveloping it, an outer layer composed of a compact and unfoamed polymer material, said unit having a first extruder for preparing the polymer melt for the core element, a second extruder for preparing the polymer melt for the outer layer, a manifold die for combining the melts such that the melt for the core element is surrounded annularly by the melt for the outer layer, an exit die, a cooling section, a takeoff device, and a cutting and chamfering device,
said coextrusion unit further comprising,
disposed between the first extruder and the manifold die, at least one static mixer, and a cooler.

10. The coextrusion unit as claimed in claim 9, further comprising a second static mixer disposed between the first extruder and the manifold die, whereby a die combination comprising said static mixer, said cooler and said second static mixer is disposed between said first extruder and said manifold die.

11. The coextrusion unit as claimed in claim 9, further comprising a gravimetric metering device for metering the polymer starting materials of the melts for the core element and for the outer layer.

12. The coextrusion unit as claimed in claim 11, wherein there is a second metering device for the chemical blowing agent of the melt for the core element such that the chemical blowing agent is introduced into the polymer pellet stream coming from the gravimetric metering device.

13. A synthetic bottle closure produced by the process as claimed in any one of claims 1 to 8.
